(19) United States
(12) Patent Application Publication
(10) Pub. No.: US 2015/0066812 A1
(43) Pub. Date: Mar. 5, 2015

(54) ENERGY MANAGEMENT SYSTEM AND METHOD THEREFOR, AND NON-TRANSITORY COMPUTER READABLE MEDIUM

(71) Applicant: KABUSHIKI KAISHA TOSHIBA, Tokyo (JP)

(72) Inventors: Keisuke MERA, Kawasaki-Shi (JP); Shigeo MATSUZAWA, Tokyo (JP)

(21) Appl. No.: 14/447,260

(22) Filed: Jul. 30, 2014

(30) Foreign Application Priority Data
Sep. 2, 2013 (JP) 2013-181406

(51) Int. Cl. G06Q 50/06; G06Q 30/02

(52) U.S. Cl. CPC G06Q 50/06; G06Q 30/0283
USPC 705/412

(57) ABSTRACT

There is provided a system including a reference consumption calculator and a load shift determining unit. The calculator calculates a reference consumption being a statistic for an energy consumption based on a history of the energy consumption of a demander. The determining unit determines whether or not load shift was performed based on and the reference consumption and a target energy consumption being the energy consumption in a period including a target time period in the history of the energy consumption, the load shift including at least one of a first operation and a second operation by the demander. The first operation is to charge energy in an energy accumulating device. The second operation is to shift an energy consumption operation to be made in a time period other than the target time period so as to be made in the target time period.

### CROSS-REFERENCE TO RELATED APPLICATIONS

This application is based upon and claims the benefit of priority from Japanese Patent Application No. 2013-181406, filed Sep. 2, 2013; the entire contents of which are incorporated herein by reference.

### FIELD

Embodiments described herein relates to an energy management system and a method therefor, and a non-transitory computer readable medium.

### BACKGROUND

Conventionally, a countermeasure against variation in output of distributed power sources including natural energy includes a method in which a demander parallels and parallels off the distributed power sources with respect to a power system, and a method in which a demander charges and discharges power generated by use of an electric storage device or heat storage device.

A method for the power system operator to manage a power consumption of the demander has included in the past a method in which the power consumption of the demander is increased and decreased by way of a demand response by use of information communicating means.

If the distributed power sources including natural energy are increased, an energy generation from the distributed power sources possibly exceeds the power consumption by the demanders to generate surplus energy. In such a case, the power system operator issues the demand response to the demander to prompt consumption of the surplus energy such that the demander increases the power consumption to allow the surplus energy to be reduced. The power system operator gives compensation to the demander who operates based on the request such that electric power charge is discounted or a financial incentive is paid.

However, the power system operator cannot identify means of power consumption by the demander, possibly bringing about various problems.

A first example of the problems may be that the power system operator cannot determine whether or not the demander effectively utilizes the surplus energy. If not effectively utilized, the surplus energy is wasted, which is inefficient.

An example of the effective utilization may be that the demander changes a schedule of the power consumption to shift the power consumption to a time period during which the surplus energy occurs, or charges the surplus energy in the electric storage device to consume the relevant energy in another time period.

An example of no-effective utilization may be that the demander operates an electrical heater unnecessary at a high temperature time in summer for consuming the surplus energy, or operates a light device unnecessary in a time period of sunshine in the daytime.

A second example of the above problems may be that unfairness may be caused between the demander who effectively utilizes the surplus power and the demander who does not effectively utilize the surplus power even if both are the demanders who consume the surplus energy. In general, the electric storage device for effectively utilizing the surplus energy is high in cost while a device not effectively utilizing the surplus energy such as the electrical heater is low in cost. Therefore, if the compensation is determined to be given based on merely whether or not the demander consumes the surplus energy, a sense of unfairness in the cost may be induced between the demanders.

### BRIEF DESCRIPTION OF THE DRAWINGS

FIG. 1 is a block diagram showing an energy management system according to the first embodiment.

FIG. 2 is a diagram showing an example of energy consumption data held in an energy consumption data storage.

FIG. 3 is a flowchart showing an operation of a reference consumption calculator.

FIG. 4 is a diagram showing an example of a reference consumption held in a reference consumption data storage.

FIG. 5 is a flowchart of a load shift determining unit.

FIG. 6 is a diagram for illustrating in detail content of a determination flow of load shift determination.

### DETAILED DESCRIPTION

According to one embodiment, there is provided an energy management system including a reference consumption calculator and a load shift determining unit.

The reference consumption calculator calculates a reference consumption being a statistic for an energy consumption based on a history of the energy consumption of a demander.

The load shift determining unit determines whether or not load shift was performed based on and the reference consumption and a target energy consumption being the energy consumption in a period including a target time period in the history of the energy consumption, the load shift including at least one of a first operation and a second operation out of a plurality of operations by the demander.

The first operation is an operation to charge energy in an energy accumulating device, the energy being supplied from at least one of a power generating device of the demander and a power system in the target time period.
The second operation is an operation to shift an energy consumption operation which is made in a time period other than the target time period so as to be made in the target time period.

Hereinafter, a description is given of an embodiment of the present invention with reference to the drawings.

### First Embodiment

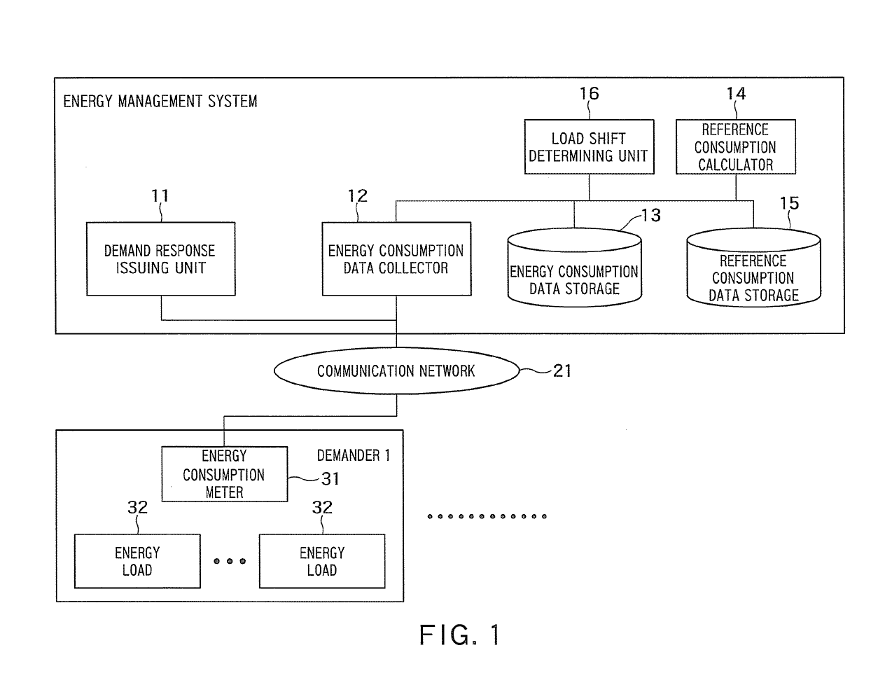

FIG. 1 is a block diagram showing an energy management system according to a first embodiment of the present invention. The energy management system according to the first embodiment includes a demand response issuing unit 11, an energy consumption data collector 12, an energy consumption data storage 13, a reference consumption calculator 14, a reference consumption data storage 15, and a load shift determining unit 16.

The energy management system is connected via a communication network 21 with an energy consumption meter 31 at a demander 1. The energy consumption meter 31 has a function of measuring energy consumption of the demander and a function of communication.

The demander 1 has one or more energy loads 32. The energy load 32 is a device consuming energy possessed by the demander. The demander 1 may have a plurality of energy consumption meters 31.

The demander may have a device accumulating energy. As an example of the energy accumulating device, there may be included a device accumulating energy in the form of electricity such as a storage battery or a device accumulating energy in the form of heat by heating water and the like such as a heating and heat-retention device. The demander may also have a power generating device such as a photovoltaic generation device.

Only one demander is shown here, but the energy management system is actually connected with a plurality of demanders via the communication network 21.

The demand response issuing unit 11 issues to the demander a request for a demand response. A kind of the request generally includes two kinds, “restraint” and “surplus measure”. The “restraint” is a request that prompts the demander to reduce consumed power in a predetermined time period. The “surplus measure” is a request that prompts the demander to increase consumed power in a predetermined time period. The present embodiment especially shows a case where the “surplus measure” is dealt with, but both the “restraint” and the “surplus measure” may be dealt with.

The energy consumption data collector 12 collects data of the energy consumption for each demander. The energy consumption data storage 13 stores a history of the energy consumption data collected by the energy consumption data collector 12.

The reference consumption calculator 14 calculates a reference consumption as a statistic for the energy consumption for each demander based on the history of the energy consumption data for each demander. The reference consumption data storage 15 stores data of the reference consumption calculated by the reference consumption calculator 14.

The load shift determining unit 16 determines, based on the energy consumption (target energy consumption) in a period including a target time period (e.g., demand response time period) and the reference consumption, whether or not the demander performed load shift in the relevant target time period in the history of the energy consumption. For example, load shift discrimination is made based on a magnitude relationship between the reference consumption and the relevant energy consumption, and a difference (subtraction or ratio) between the reference consumption and the relevant energy consumption.

Here, the load shift includes at least one of an operation by the demander to shift an energy consumption operation usually made in a time period other than the target time period to the target time period and an operation to charge energy in the energy accumulating device, and further may include an operation to use the charged energy in a time period other than the time period during which the accumulation was performed.

For example, there may be included a case where power generated by the photovoltaic generation device in the daytime or power supplied from a power system is charged in the storage battery and the charged power is used in the nighttime for operating a light or an air-conditioning device. In addition, there may be included a case where water is heated by use of the power generated by the photovoltaic generation device in the daytime and the heated water is consumed by a hot-water supply device or an air-conditioning device in the nighttime. The load shift allows to separate a time period during which to generate and charge the energy from a time period during which to use the energy, enabling power demand restraint or power surplus measure for each time period.

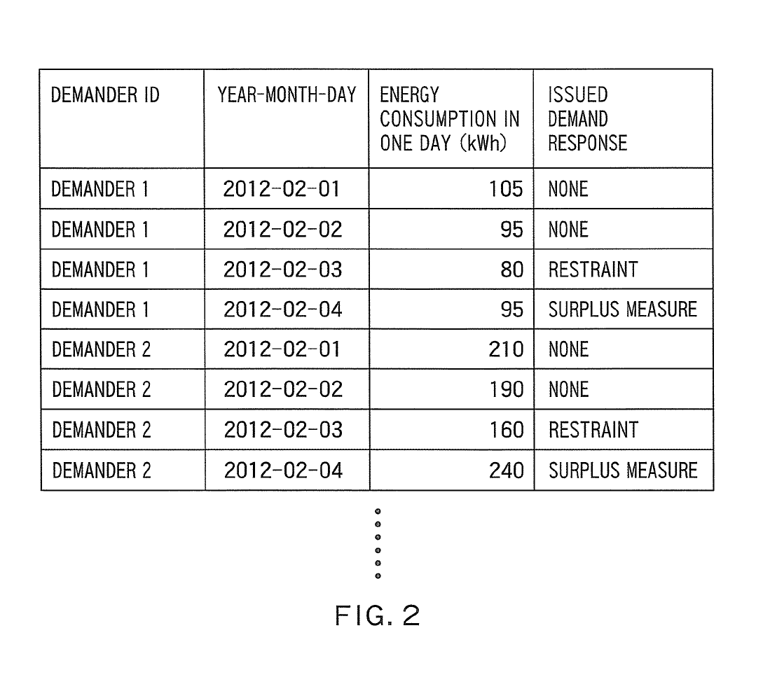

By use of FIG. 2 to FIG. 5, a description is given of an operation of the system according to the first embodiment of the present invention.

FIG. 2 shows an example of the energy consumption data held by the energy consumption data storage 13.

For each demander, a power consumption (integration value) for each day and issuance or no-issuance and kinds of the demand response are presented. However, the form of the energy consumption data is not necessarily limited to this form and another form may be used so long as information necessary for calculating the reference consumption described later is included. For example, a form of power consumption (integration value) for every 30 minutes may be used. Alternatively, in a case of the demander having a plurality of meters (energy consumption meter 31), data may be used in which values of the plurality of meters with respect to one demander are described.

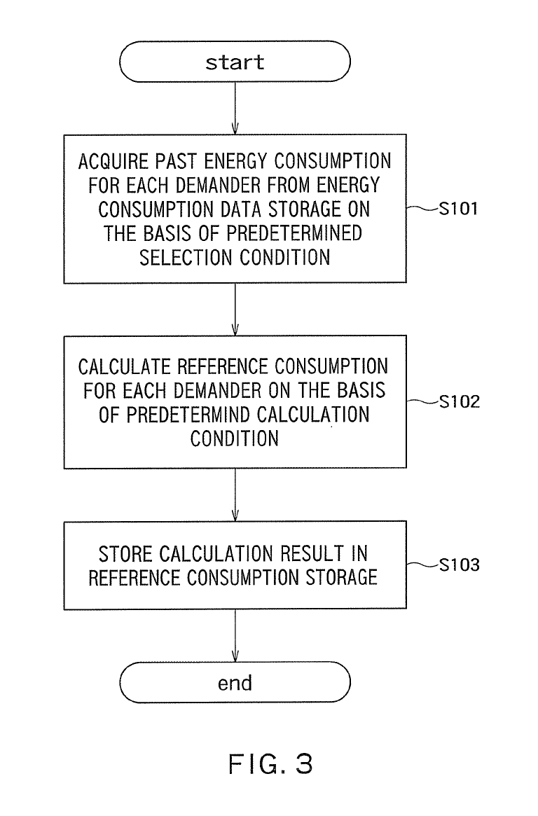

FIG. 3 is a flowchart showing an operation of the reference consumption calculator 14.

The reference consumption calculator 14 selects data from past energy consumption data for each demander based on a predetermined selection condition (S101). By use of the selected data, the reference consumption (statistic) is calculated for each demander based on a predetermined calculation condition (S102). Data of the reference consumption calculated for each demander is stored in the reference consumption data storage 15 (S103).

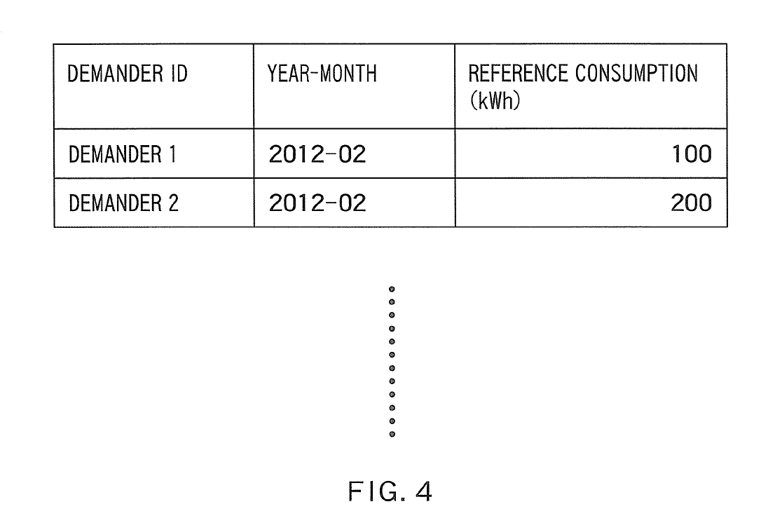

FIG. 4 shows a data example of the reference consumption held by the reference consumption data storage 15.

Here, the selection condition for consumed energy used in a process at step S101 in FIG. 3 is set to “energy consumption on days with no issuance of the demand response” in February, 2012. The calculation condition for the reference consumption used in a process at step S102 in FIG. 3 is set to “(simple) mean value”.

It is presented that the demander 1 has the mean value of the energy consumption of 100 kWh on days with no issuance of the demand response in February, 2012. It is presented that a demander 2 has the mean value of the energy consumption of 200 kWh on days with no issuance of the demand response in February, 2012. For a demander 3 and subsequent demanders, the reference consumptions are similarly calculated, but the illustration thereof is omitted here.

Here, a case is assumed where the current day is Feb. 5, 2012 as an example, but not limited thereto. Note that the selection condition for a power consumption and the calculation condition for the reference consumption used here are merely examples, and other kinds of selection conditions and calculation conditions may be used as in other embodiments described later.

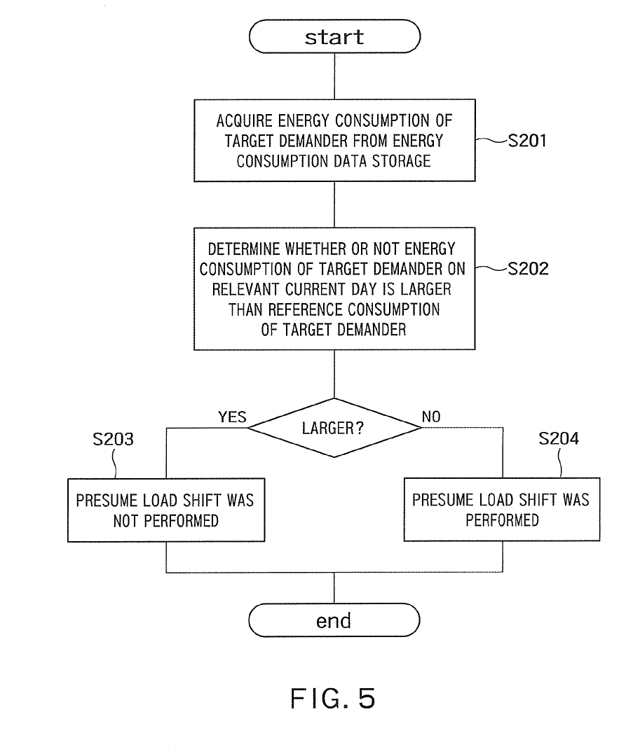

FIG. 5 is a flowchart of the load shift determining unit 16.

Here, a specific example is shown as an example of a case where a target demander on which load shift discrimination is made is the “demander 1”, and the current day is “2012-02-04” (the day when a demand response for the surplus measure was issued).

First, the energy consumption data of the target demander (a value “95” on Feb. 4, 2012 from FIG. 2 in this example) is acquired from the energy consumption data storage 13 (S201).

Next, the reference consumption of the target demander (a value “100” from FIG. 4 in this example) is acquired from the reference consumption data storage 15 (S202). Then, whether or not the energy consumption is larger than the reference consumption is determined.

If the energy consumption is larger than the reference consumption, it is presumed that the target demander “did not perform the load shift” (S203) and if the energy consumption is not larger (i.e., is equal to or smaller) than the reference consumption, the load shift determining unit 16 presumes that the target demander “performed the load shift” (S204). In this case, since the energy consumption of the demander 1 is not larger (is smaller) than the reference consumption, the load shift determining unit 16 presumes that the demander 1 “performed the load shift”.

An example of criteria for the load shift discrimination is set to whether or not the energy consumption is larger than the reference consumption here, but is not limited thereto and other criteria may be used. For example, with taking into account a measurement error or the like, a value of the reference consumption may have a margin. In other words, so long as a difference between the energy consumption and the reference consumption is equal to or less than a certain value, the load shift may be determined to have been performed or the load shift may be determined to have not been performed.

The above example shows the case of the demander 1, whereas a specific example is shown of a case where the target demander on which the load shift discrimination is made is the demander 2, and the current day is “2012-02-04” (the day when a demand response for the surplus measure was issued).

In this case, the energy consumption of the target demander is “240” and the reference consumption of the target demander is “200”. Since the energy consumption is larger than the reference consumption, the load shift determining unit 16 presumes that the demander 2 “did not perform the load shift”.

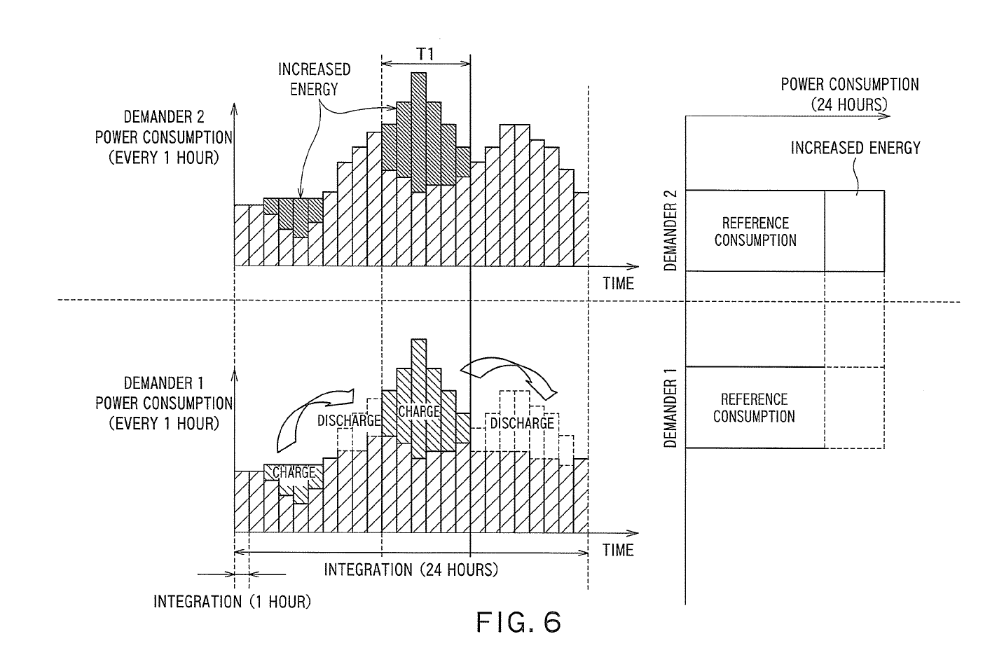

A description is given in detail of content of the determination flow of the load shift determination with reference to FIG. 6.

A bar chart in the upper left of FIG. 6 illustrates an example of the power consumption of the demander 2 who did not perform the load shift (i.e., who wasted energy or caused increased energy) and a bar chart in the lower left of FIG. 6 illustrates an example of the power consumption of the demander 1 who performed the load shift. The bar chart with hatched lines (having three kinds of spacing, coarse spacing, middle spacing and fine spacing) illustrates actually power consumptions. The bar chart having the middle spacing illustrates electricity power charged in the storage battery out of the actually power consumption. The bar chart having the fine spacing illustrates increased power consumption (wasted power consumption) out of the actually power consumption. The bar chart having the coarse spacing illustrates electric energy normally used other than the above. The bar chart vertical indicated by a broken line and filled with white color illustrates electric energy discharged from the storage battery.

A time period T1 is a predetermined time period (surplus measure demand response target time period) included in a request for the “surplus measure” demand response issued by the demand response issuing unit 11. In the example, the time period T1 corresponds to a time period during which an intensity of sunshine is strong in the daytime and the electric energy generated by way of photovoltaic generation as one of the distributed power sources is prone to become increased.

In the demander 1, the power is charged in the storage battery (e.g., charged by automatic control) in the time period T1 to increase the consumed power in the time period, but the power is discharged from the storage battery in other than in the time period T1 to decrease the power consumption entirely (in one day). This is a result from the load shift by the demander 1. On the other hand, in the demander 2, as compared with the demander 1, the consumed power does not decrease in a time period other than the time period T1. This is a result from no load shift by the demander 2 (the storage battery is not charged in the time period T1).

Then, as for integral in one day, as shown in charts in the right of FIG. 6, the demander 1 who performed the load shift has the power consumption as much as the reference consumption, whereas the demander 2 who did not perform the load shift has the power consumption exceeding the reference consumption. Therefore, it is possible to presume whether or not the load shift was performed based on the comparison between the energy consumption and the reference consumption as the determination flow shown in FIG. 5.

A description is given below of an exemplary utilization of the result of the load shift determination.

As a first example, in a case where the demander is determined to have not performed the load shift after the request for the surplus measure to the demander by the power system operator (see S203 in FIG. 5), the demander may be requested to perform the load shift in the time to come. Alternatively, an incentive as the compensation for the request made to the demander may be decreased (i.e., penalty is imposed), or the request may not be made to the demander in the time to come (i.e., the demander is not given the incentive in the time to come). Alternatively, while these matters to be performed unless the load shift is performed are informed as a warning, the request for the load shift to be performed may be made in the time to come.

As a second example, in a case where the demander is determined to have performed the load shift after the request for the surplus measure to the demander by the power system operator, with respect to the demander, the incentive as the compensation for the request made to the demander may not be decreased (i.e., penalty is not imposed), the incentive may be increased, or the request to the demander may be to be continued in the time to come as well (i.e., the demander is given the incentive in the time to come as well).

In the above examples, the determination is made on whether or not the load shift was performed in the time period for the surplus measure in the past (e.g., yesterday), but a configuration for determining in real time may be possible. In other words, it is possible that whether or not the load shift was performed in the surplus measure time period is determined and that the operation depending on the exemplary utilization as above is performed based on the determination result.

As described above, the power system operator can presume whether or not the demander effectively utilizes the surplus energy to prompt the demander to effectively use the surplus energy. In addition, fairness in the cost (expense) can be improved between the demanders.

### Second Embodiment

The present embodiment describes in detail the selection condition for the power consumption used by the reference consumption calculator 14 for calculating the reference consumption (see S101 in FIG. 3).

The selection condition for the power consumption includes, as an example, selection of the power consumption in a predetermined time period. Various time intervals may be conceivable for the predetermined time period, for example, every one hour (e.g., from 13 to 14 o'clock, from 14 to 15 o'clock, or the like), every several hours (e.g., from 12 to 15 o'clock, or the like), one day, several days, one week, one month, several months (seasons) and the like.

However, as for the selection condition for the power consumption, preferably selected is the power consumption integrated (accumulated) at a time interval suitable for presuming the load shift of the demander according to an intention of the present application. For example, if the load shift of the demander is performed in about one day at most, the power consumption in about one day or a time period shorter than that is preferably selected.

Additionally, as for the selection condition for the power consumption, preferably selected is the power consumption on a day with no issuance of the demand response according to an intention of a reference power consumption. This is because the demander has a relatively low possibility to do operation to intentionally decrease or increase the consumed power on the day with no issuance of the demand response.

Further, as for the selection condition for the power consumption, the power consumption on a predetermined kind of day may be considered to be selected. The predetermined kind of day includes a day in the same season in the last year and years previous, a day of the week (weekday, Saturday, Sunday, public holiday), an operating day or non-operating day of the demander, and presence or absence of the demander, for example. Depending on presence or absence of the demander in a residence thereof, or operation or non-operation of an office of the demander, characteristics of the power consumption of the demander have a high possibility to be varied. In consideration of such situations, it is preferable to distinguish the predetermined kinds of day from each other to select the power consumption.

In addition, as for the selection condition for the power consumption, a predetermined environmental factor may be considered to be included in the condition. As the predetermined environmental factor, for example, an ambient value such as an outside air temperature around the demander, humidity, rainfall, and sunshine is abnormally high (large) or low (small) in the wrong season, which is out of a certain range. On such a day, the characteristics of the power consumption of the demander have a high possibility to be varied. Therefore, it is preferable to exclude the values regarding the day in the wrong seasons to select the power consumption, that is, to select the power consumption on a day of which the ambient values fall within the certain range.

Further additionally, as the selection condition for the power consumption, out of values of a plurality of the power consumptions of the demander a value largely deviated from the mean value (so-called outlier) is considered to be excluded. This allows the power consumption to be selected with taking into account a case where the energy consumption operation by the demander is unusual (e.g., in getting a visitor, in holding an event, inspection or construction affecting the energy consumption).

Note that the condition for selecting the power consumption used for calculating the reference consumption is preferably not known by the demander. This is because the demander may possibly intentionally decrease or increase the power consumption.

### Third Embodiment

The present embodiment describes in detail the calculation condition for calculating the reference consumption from the power consumption which is selected by the reference consumption calculator 14 (see S102 in FIG. 3).

As for the calculation condition for the reference consumption, statistics such as a mean value, median value, intermediate value and mode value may be calculated based on the value of the power consumption of the demander selected based on the above described selection condition. For example, the mean value may be calculated based on the power consumption selected based on the above selection condition.

Further, the calculation condition for the reference consumption may be considered to be variously modified.

For example, in a case where the demander starts to use a device as the energy load 32 additionally, which leads to increase of an average energy consumption, the reference consumption is preferably adjusted. As for an example of an adjustment manner, the reference consumption may be periodically calculated to always use the latest reference consumption for the load shift determination or the mean value of a plurality of reference consumption in the past (so-called moving average deviation) may be used for the load shift determination. In the case of the former manner, the load shift determination always with the latest reference consumption is preferably enabled, but a problem may occur as follows: temporal increase and decrease of the energy consumption of the demander may easily exert influence. On the other hand, in the case of the latter manner, the influence of the temporal increase and decrease of the energy consumption of the demander can be preferably relaxed.

In another example, even in a case where the environmental factor such as temporal fluctuation of temperature occurs, the reference consumption is preferably adjusted. As for an adjustment manner, the outside air temperature at the time or in the time period when measuring the energy consumption of the demander used for calculating the reference consumption is compared with the outside air temperature at the time or in the time period when measuring the energy consumption of the demander used for the load shift determination, and depending on a difference between those outside air temperatures, the reference consumption or the energy consumption is adjusted. Alternatively, as another reference consumption, an example may apply a reference consumption calculated at the time (in the season) when an outside air temperature is obtained closer to the outside air temperature in the load shift determination.

Further, as an example of another reference consumption, variation of the energy consumption of another demander may be considered to be added. For example, if the energy consumption of another demander increases or decreases as a whole, the reference consumption of the relevant demander may be increased or decreased at a rate of the increase or decrease. For example, based on the history of the energy consumption of another demander, a ratio is calculated between the energy consumption in a target period and the energy consumption in another period prior to the target period. The prior another period may be the day the same as in a year before the target period, a day closer to the relevant day, a day the same in the environmental condition as the target period, or the like. Representative values such as the mean, mode or median value of the calculated ratios are calculated, and the reference consumption of the relevant demander is amended depending on the ratios of the representative values. For example, the reference consumption is multiplied by the ratio to be amended. Here, calculation is performed from the energy consumption of another demander, but the calculation may be performed with the energy consumption of the relevant demander being included. The load shift determining unit makes the determination on the load shift by use of the amended reference consumption.

The energy management system as described above may also be realized using a general-purpose computer device as basic hardware. That is, processing of each block in the system shown in FIG. 1 can be realized by causing a processor mounted in the above general-purpose computer device to execute a program. In this case, the server apparatus and the communication apparatus may be realized by installing the above described program in the computer device beforehand or may be realized by storing the program in a storage medium such as a CD-ROM or distributing the above described program over a network and installing this program in the computer device as appropriate. Furthermore, each storage in the system may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An energy management system comprising:
a reference consumption calculator to calculate a reference consumption being a statistic for an energy consumption based on a history of the energy consumption of a demander; and
a load shift determining unit to determine whether or not load shift was performed based on the reference consumption and a target energy consumption being the energy consumption in a period including a target time period in the history of the energy consumption, the load shift including at least one of a first operation and a second operation out of a plurality of operations by the demander,
a first operation being an operation to charge energy in an energy accumulating device, the energy being supplied from at least one of a power generating device of the demander and a power system in the target time period, and
a second operation being an operation to shift an energy consumption operation which is made in a time period other than the target time period so as to be made in the target time period.

2. The system according to claim 1, wherein
the load shift determining unit determines whether or not the load shift was performed based on a difference between the target energy consumption and the reference consumption.

3. The energy management system according to claim 1, wherein
the load shift determining unit determines that the load shift was performed in a case where a value obtained by subtracting the reference consumption from the target energy consumption is less than a certain value, and that the load shift was not performed in a case where the value is equal to or more than the certain value.

4. The energy management system according to claim 1, wherein
the reference consumption calculator calculates the reference consumption based on the energy consumption in a time period satisfying a predefined condition in the history of the energy consumption.

5. The energy management system according to claim 1, wherein
the reference consumption calculator calculates the reference consumption based on the energy consumption in a time period other than the target time period in the history of the energy consumption.

6. The energy management system according to claim 5, wherein
the reference consumption calculator calculates the reference consumption based on energy consumption data in a time period in which ambient values of the demander fall within a predetermined range.

7. The energy management system according to claim 1, wherein
the reference consumption calculator calculates a ratio between the energy consumption in a period including the target time period and the energy consumption in a first period prior to the period based on a history of an energy consumption of another demander, and amends the reference consumption of the demander depending on the ratio, and
the load shift determining unit determines whether or not the load shift was performed by use of the amended reference consumption.

8. The energy management system according to claim 1, wherein
the reference consumption calculator calculates, as the reference consumption, a mean value, a median value, an intermediate value, or a mode value of the energy consumption.

9. The energy management system according to claim 1, wherein
the reference consumption calculator calculates periodically or at any time interval the reference consumption to acquire a plurality of reference consumptions, and
the load shift determining unit determines whether or not the load shift was performed based on a mean value or moving average deviation of the plurality of reference consumptions and the target energy consumption.

10. The energy management system according to claim 1, wherein
the target time period is a time period in which a demand response was requested to the demander.

11. The energy management system according to claim 1, wherein
a third operation is to use energy charged in the target time period after the target time period and the load shift includes at least one of the first operation, the second operation and the third operation.

12. A non-transitory computer readable medium having instruction stored therein, which when executed by a processor, causes the processor to execute processing of steps comprising:
calculating a reference consumption as a statistic for an energy consumption based on a history of the energy consumption of a demander; and
determining whether or not load shift was performed based on and the reference consumption and a target energy consumption being the energy consumption in a period including a target time period in the history of the energy consumption, the load shift including at least one of a first operation and a second operation out of a plurality of operations by the demander,
the first operation being an operation to charge energy in an energy accumulating device, the energy being supplied from at least one of a power generating device of the demander and a power system in the target time period, and
the second operation being an operation to shift an energy consumption operation which is made in a time period other than the target time period so as to be made in the target time period.

13. A method performed in a device including a processor, comprising:
calculating a reference consumption as a statistic for an energy consumption based on a history of the energy consumption of a demander; and
determining whether or not load shift was performed based on and the reference consumption and a target energy consumption being the energy consumption in a period including a target time period in the history of the energy consumption, the load shift including at least one of a first operation and a second operation out of a plurality of operations by the demander,
the first operation being an operation to charge energy in an energy accumulating device, the energy being supplied from at least one of a power generating device of the demander and a power system in the target time period, and
the second operation being an operation to shift an energy consumption operation which is made in a time period other than the target time period so as to be made in the target time period.
